(19) United States
(12) Patent Application Publication
(10) Pub. No.: US 2018/0333910 A1
(43) Pub. Date: Nov. 22, 2018

(54) THREE-DIMENSIONAL PRINTING GUN

(71) Applicant: Walmart Apollo, LLC, Bentonville, AR (US)

(72) Inventors: Yurgis Mauro Bacallao, Centerton, AR (US); Bridget Leffler, Bentonville, AR (US)

(21) Appl. No.: 15/960,712

(22) Filed: Apr. 24, 2018

Related U.S. Application Data
(60) Provisional application No. 62/508,852, filed on May 19, 2017.

(51) Int. Cl. B29C 64/118; B29C 73/02; B29C 64/209; B33Y 10/00; B33Y 30/00

(52) U.S. Cl. CPC B29C 64/118; B29C 73/02; B33Y 30/00; B33Y 10/00; B29C 64/209

(57) ABSTRACT

A three-dimensional printing gun is provided, including: a 3D printing filament source removably attached to a housing, a 3D filament advancing mechanism configured to advance a 3D filament through a barrel portion, a heating element coupled to the front end of the barrel portion of the housing, the heating element having an internal bore configured to receive the advanced 3D filament from the 3D filament advancing mechanism and heat the 3D filament to a hot molten 3D printing material to be discharged from an outlet of a nozzle of the heating element, as part of the actuation of the actuator, and an insulator sleeve surrounding the heating element. Furthermore, an associated method is also provided.

### CROSS REFERENCE TO RELATED APPLICATION[S]

This application claims the benefit of U.S. Provisional application No. 62/508,852, filed May 19, 2017, the contents of which are incorporated herein in their entirety.

### FIELD OF TECHNOLOGY

The following relates to a three-dimensional molding printing gun, and more specifically to embodiments of a portable three-dimensional printing gun for melting a filament.

### BACKGROUND

Most three-dimensional (3D) printing is performed by 3D printing machines to create new objects of various sizes out of thermoplastic material.

### SUMMARY

A first aspect relates generally to a three-dimensional printing gun, comprising: a 3D printing filament source removably attached to a housing of the three-dimensional printing gun, a 3D filament advancing mechanism configured to advance a 3D filament through a barrel portion, the 3D filament advancing mechanism including a plurality of gears configured to advance the 3D filament towards the front end of the barrel portion of the housing, in response to an actuation of an actuator, the actuator being a trigger that is at least partially located external to the housing for actuation by a finger of a user, a heating element coupled to the front end of the barrel portion of the housing, the heating element having an internal bore configured to receive the advanced 3D filament from the 3D filament advancing mechanism and heat the 3D filament to a hot molten 3D printing material to be discharged from an outlet of a nozzle of the heating element, as part of the actuation of the actuator, wherein the heating element includes a plurality of cooling fins radially extending from the heating element, and an insulator sleeve surrounding the heating element.

A second aspect relates generally to a 3D printing gun comprising: a housing having a barrel portion and a handle portion perpendicular to the barrel portion, wherein a user grips the handle portion when using the 3D printing gun, a 3D printing filament spool device fastened to the housing of the three-dimensional molding printing gun, a 3D filament advancing mechanism for advancing the 3D filament through an internal passageway of the barrel portion, the 3D filament advancing mechanism including a first gear positioned proximate a motor arm in the barrel portion of the housing, the first gear meshing with a second gear positioned below the 3D filament, the second gear cooperating with a third gear positioned above the 3D filament, such that the 3D filament is advanced towards the front end of the barrel portion via contact with the second gear and the third gear, a heating element threadably coupled to the first end of the barrel portion of the housing, the heating element having an internal bore aligned with the internal passageway of the barrel portion, and configured to receive the advanced 3D filament from the 3D filament advancing mechanism and heat the 3D filament to a hot molten 3D printing material to be discharged from an outlet of a nozzle of the heating element, wherein the heating element includes a plurality of cooling fins radially extending from the heating element, and an insulator sleeve surrounding the heating element, wherein, when a trigger is pulled by a user: (i) a portion of the trigger located inside the housing makes contact with a switch of a gear motor located inside the housing, which actuates the motor arm connected to the first gear, which causes motion of the first gear and the second gear to advance the 3D filament for dispensing from the nozzle as a hot molten filament, and (ii) the heating element is caused to melt the 3D filament located within the internal bore of the heating element.

A third aspect relates generally to a method of discharging a hot molten filament, the method comprising: providing a 3D printing gun, the 3D printing gun including a 3D printing filament source removably attached to a housing of the three-dimensional molding printing gun, a 3D filament advancing mechanism configured to advance a 3D filament through a barrel portion of the housing from a rear end to a front end, the 3D filament advancing mechanism including a plurality of gears configured to advance the 3D filament towards the front end of the barrel portion of the housing, a heating element coupled to the first end of the barrel portion of the housing, the heating element having an internal bore configured to receive the advanced 3D filament from the 3D filament advancing mechanism, wherein the heating element includes a plurality of cooling fins radially extending from the heating element, and an insulator sleeve surrounding the heating element, and in response to an actuation of an actuator: (i) advancing the 3D filament through the barrel portion of the housing, wherein the actuator is a trigger that is at least partially located external to the housing for actuation by a finger of a user, (ii) heating the 3D filament to a hot molten 3D printing material to be discharged from an outlet of a nozzle of the heating element

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a perspective of a 3D printing gun, in accordance with embodiments of the present invention;

FIG. 2 depicts a cross-sectional view of the 3D printing gun, in accordance with embodiments of the present invention.

FIG. 3 depicts an attachment mechanism of the 3D printing filament source, in accordance with embodiments of the present invention.

FIG. 4 depicts a perspective view of an attachment mechanism and a filament supply device in an operable configuration, in accordance with embodiments of the present invention.

FIG. 5 depicts a rear view of the heating element, in accordance with embodiments of the present invention.

FIG. 6 depicts the heating element receiving the insulator sleeve, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

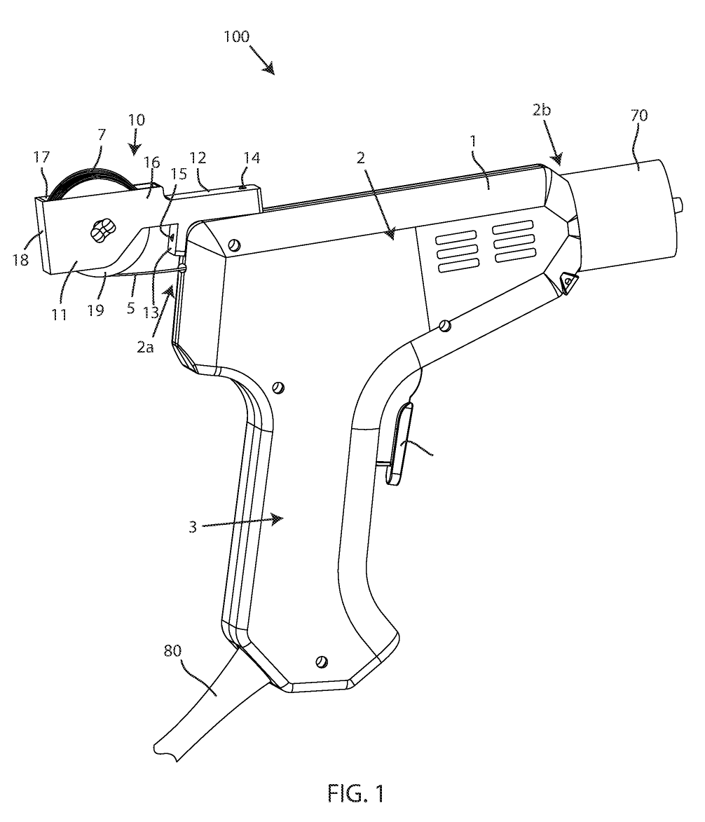

Referring to the drawings, FIG. 1 depicts an embodiment of a 3D printing gun 100. Embodiments of the 3D printing gun 100 may be a portable three-dimensional printing device, a 3D printing molding gun, a portable thermoplastic heating device, a thermoplastic melting gun, a thermoplastic heating gun, and the like. Embodiments of the 3D printing gun 100 may be used on a salesfloor for a plurality of tasks, operations, repairs, and the like. For example, embodiments of the 3D printing gun 100 may be used to enable 3D printed pieces to be fused together to create bigger final products, which may not be possible for a conventional 3D printing machine. Embodiments of the 3D printing gun 100 may also enable real-time fixes for broken parts 3D printed for display and/or use by a retailer, business, warehouse, etc., allow for personalization of 3D printed items to be created in the field or in response to a specific request.

Moreover, embodiments of the 3D printing gun 100 may include a housing 1. Housing 1 may define an outer structure of the 3D printing gun 100, and may enclose various internal components of the 3D printing gun 100. Embodiments of the housing 1 may be comprised of two half-shells that may be joined together to form the housing 1 of the gun 100. The housing 1 may be comprised of a plastic, a lightweight material, a composite, a metal, and/or a combination thereof.

Embodiments of the 3D printing gun 100 may include a barrel portion 2 and a handle portion 3. The barrel portion 2 may be perpendicular or substantially perpendicular to the handle portion 3. The barrel portion 2 of the 3D printing gun 100 may include a first end 2a and an opposing second end 2b. The handle portion 3 may be gripped or otherwise held by a user when operating the 3D printing gun 100. During operation of the 3D printing gun 100 or at least when being held by the user, the barrel portion 2 may extend axially a distance from the user's hand. Further, embodiments of the barrel portion 2 and the handle portion 3 may be structurally integral, forming portions of the housing 1.

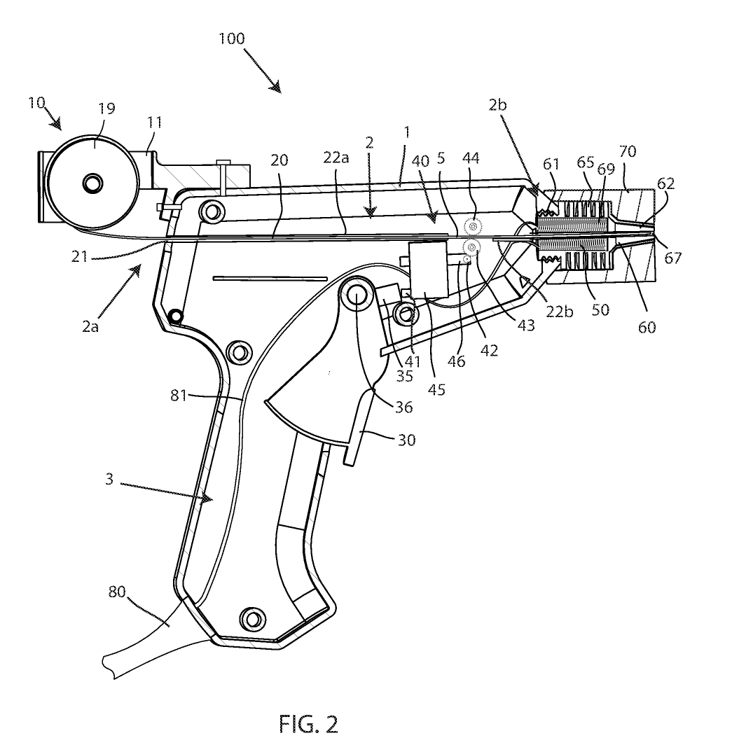

Referring now to FIGS. 1-2, embodiments of the 3D printing gun 100 may include a 3D printing filament source 10, a 3D filament advancing mechanism 40, an actuator 30, a heating element 60, and an insulator sleeve 70.

In an exemplary embodiment, the 3D printing gun 100 may include a 3D printing filament source 10 removably attached to a housing 1 of the three-dimensional printing gun 100, a 3D filament advancing mechanism 40 configured to advance a 3D filament 5 through a barrel portion 2 of the housing 1 from a rear end 2a to a front end 2b, the 3D filament advancing mechanism 40 including a plurality of gears 42, 43, 44 configured to advance the 3D filament 5 towards the front end 2b of the barrel portion 2 of the housing 1, in response to an actuation of an actuator 30, the actuator 30 being a trigger that is at least partially located external to the housing 1 for actuation by a finger of a user, a heating element 60 coupled to the front end 2b of the barrel portion 2 of the housing 1, the heating element 60 having an internal bore 67 configured to receive the advanced 3D filament 5 from the 3D filament advancing mechanism 40 and heat the 3D filament 5 to a hot molten 3D printing material to be discharged from an outlet of a nozzle 62 of the heating element 60, as part of the actuation of the actuator 30, wherein the heating element 60 includes a plurality of cooling fins 65 radially extending from the heating element 60, and an insulator sleeve 70 surrounding the heating element 60.

In another exemplary embodiment, the 3D printing gun 100 may include a housing 1 having a barrel portion 2 and a handle portion 3 perpendicular to the barrel portion 2, wherein a user grips the handle portion 3 when using the 3D printing gun, a 3D printing filament spool device 10 fastened to the housing 1 of the three-dimensional molding printing gun 100, a 3D filament advancing mechanism 40 for advancing the 3D filament 5 through an internal passageway 20 of the barrel portion 2, the 3D filament advancing mechanism 40 including a first gear 42 positioned proximate a motor arm 46 in the barrel portion 2 of the housing 1, the first gear 42 meshing with a second gear 43 positioned below the 3D filament 5, the second gear 42 cooperating with a third gear 44 positioned above the 3D filament 5, such that the 3D filament 5 is advanced towards the front end 2b of the barrel portion 2 via contact with the second gear 43 and the third gear 44, a heating element 60 threadably coupled to the front end 2b of the barrel portion 2 of the housing 1, the heating element 60 having an internal bore 67 aligned with the internal passageway 20 of the barrel portion 1, and configured to receive the advanced 3D filament 5 from the 3D filament advancing mechanism 40 and heat the 3D filament 5 to a hot molten 3D printing material to be discharged from an outlet of a nozzle 62 of the heating element 60, wherein the heating element includes a plurality of cooling fins 65 radially extending from the heating element 60, and an insulator sleeve 70 surrounding the heating element 60, wherein, when a trigger 30 is pulled by a user: (i) a portion of the trigger 30 located inside the housing makes contact with a switch 41 of a gear motor 45 located inside the housing 1, which actuates the motor arm 46 connected to the first gear 42, which causes motion of the first gear 42 and the second gear 43 to advance the 3D filament 5 for dispensing from the nozzle 62 as a hot molten filament, and (ii) the heating element 60 is caused to melt the 3D filament located within the internal bore 67 of the heating element 60.

Embodiments of the 3D printing gun 100 may include a 3D printing filament source 10. Embodiments of the 3D printing filament source 10 may be a filament source, a filament cord source, a thermoplastic source, a filament supply, a 3D printing material source, and the like. Embodiments of the 3D filament source 10 may be operably attached to the housing 1 of the gun 100. In an exemplary embodiment, the 3D filament source 10 may be fastened to the housing 10 by one or more fasteners via holes 14, 15. The filament source 10 may be operably connected to a first end 2a or a rear end 2a of the barrel portion 1 of the housing 1.

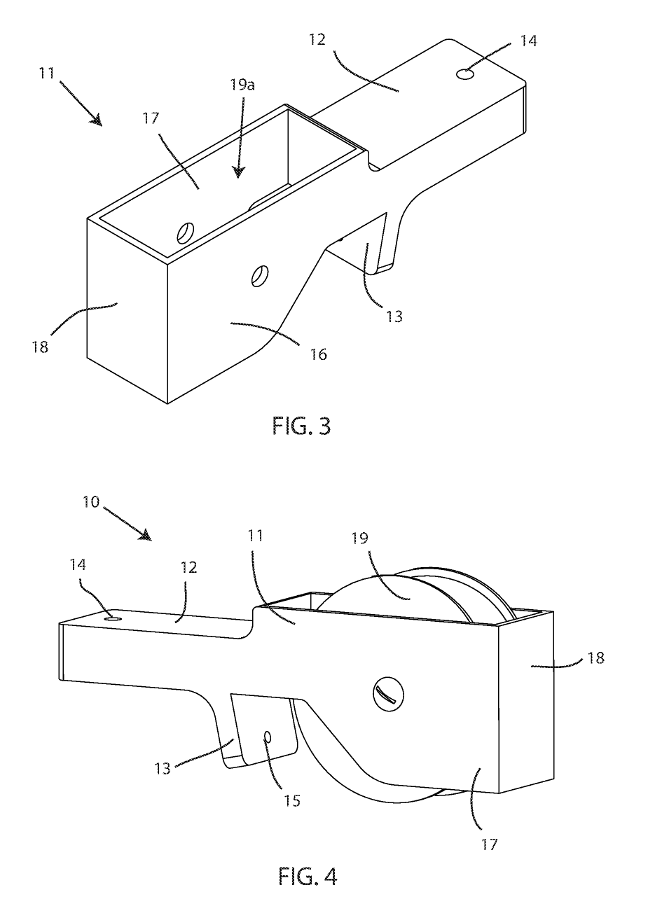

Moreover, embodiments of the 3D printing filament source 10 may include an attachment mechanism 11 and a filament supply device 19. FIG. 3 depicts an attachment mechanism 11 of the 3D printing filament source 10, in accordance with embodiments of the present invention. Embodiments of the attachment mechanism 11 may attach, connect, fasten, adhere, affix, etc. to the housing 1, proximate, at, or otherwise near the rear end 2a of the barrel portion 1 of the housing 1. Embodiments of the attachment mechanism 11 may include a first connection portion 12 and a second connection portion 13. The first connection portion 12 may be a section or portion of the attachment mechanism 11 that engages a top surface of the housing 1, when operably attached to the housing 1. The first connection portion 12 may be an extension portion that extends from a filament supply receiving area 19a. Embodiments of the first connection portion 12 may include at least one through-hole 14 for operably connecting the attachment mechanism 11 to the housing 1. Further, the second connection portion 13 may be a section or portion of the attachment mechanism 11 that engages a back or rear surface of the housing 1, when operably attached to the housing 1. The second connection portion 13 may extend in a generally downward direction from the filament supply receiving area 19a. Embodiments of the second connection portion 13 may include at least one through-hole 15 for operably connecting the attachment mechanism 11 to the housing 1. In an exemplary embodiment, the first connection portion 12 and the second connection portion 13 are structurally integral.

Embodiments of the attachment mechanism 11 may include a filament supply receiving area 19a. Embodiments of the filament supply receiving area 19a may be defined by a plurality of walls, such as side walls 16, 17 and end wall 18, wherein a space, region, gap, void, opening, between the walls 16, 17, 18 may receive, accommodate, accept, etc. a filament supply device 19. FIG. 4 depicts a perspective view of an attachment mechanism 11 and a filament supply device 19 in an operable configuration, in accordance with embodiments of the present invention. Embodiments of the filament supply device 19 may be a device, object, mechanism, or means for holding, carrying, supplying, storing, delivering, etc. a filament supply 7. In an exemplary embodiment, the filament supply device 19 may be a spool, wherein a length of filament cord 7 is wound around the spool. The filament supply device 19 may be supported within the filament supply receiving area 19a of the attachment mechanism 11 by a central axle that passes through a central opening of the filament supply device 19 and engages side walls 16, 17. In an exemplary embodiment, the central axle may be a bolt, wherein the bolt passes through an opening on the side wall 16 and an opening on the side wall 17, and a nut, such as a wing nut, is threaded on the end of the bolt to removably secure the filament supply device 19 to the attachment mechanism 11.

Referring back to FIGS. 1-2, a filament portion 5 of the filament supply 7 may be feed from the filament supply device 19 into the housing 1 via a filament entry opening 21 on the housing 1. Embodiments of the filament entry opening may be an access point, an opening, an inlet, a hole, a gap, a filament entry point, an entry opening, and the like, positioned proximate, at, or otherwise near the rear end 2a of the barrel portion 2 of the housing 1. The filament portion 5 may be feed through the filament entry opening 21 of the housing 1 and into an internal passageway 20 within the housing 1. Embodiments of the internal passageway 20 may be a bore, a tunnel, a channel, a cylindrical opening, an axial passageway, an axial opening, and the like, extending axially from a rear end 2a of the barrel portion 1 towards the front end 2b of the barrel portion 2. For example, the internal passageway 20 may extend from the rear end 2a of the housing 1 towards the 3D printing filament advancing mechanism 40. Embodiments of the internal passageway 20 may be defined by a first support structure 22a. Embodiments of the first support structure 22a may be a cylinder, a tube, a tunnel, and the like, formed within the housing 1, wherein a central axial opening of the support structure 22a is the internal passageway 20. Embodiments of the support structure 22a may extend until a close proximity to one or more gears 42, 43, 44 of the advancing mechanism 40. A second support structure 22b defining a second length of the internal passageway 20, in alignment with a first length of the internal passageway 20 defined by the first support structure 22a, may be located on the other side of the advancing mechanism 40 (i.e. closer to front end 2b) to receive the filament 5 after passing through the gears 43, 44 and carrying the filament 5 to the heating element 60, as described in greater detail infra. The support structures 22a, 22b may be secured to the housing 1 by a plurality of cross-members that extend from the inner surface of the housing 1, transverse to the tubular or axial support structures, 22a, 22b, and connect, engage, support, etc. the centrally located support structures 22a, 22a.

In an exemplary embodiment, a user may feed a leading portion of the filament 5 manually into the entry opening 21 of the housing until the leading end/portion of the filament 5 engages, coacts, cooperates, contacts, etc. with the 3D printing filament advancing mechanism 40. The internal passageway 20 may act as a guide as the filament 5 is fed through the barrel portion 2 of the housing 1. In response to activation of the 3D printing filament advancing mechanism 40, the filament 5 may be advanced further towards the front end 2b of the barrel portion 2 and into a second length of the internal passageway 20.

Referring now to FIG. 2, embodiments of the 3D printing gun 100 may include a 3D printing filament advancing mechanism 40 and an actuator 30. Embodiments of the 3D filament advancing mechanism 40 may be configured to advance a 3D printing filament 5 through the barrel portion 2 of the housing 1. For example, the 3D printing filament advancing mechanism 40 may advance the filament through a barrel portion 1 from the rear end 2a to the front end 2b of the barrel portion 2, and/or from a point within the housing 1 (e.g. proximate the gears 43, 44) to an outlet of the nozzle 62 of the heating element 60. Embodiments of the 3D printing filament advancing mechanism 40 may include a motor 45 and a plurality of gears 42, 43, 44, which may work in concert to advance the filament 5 through the gun 100.

The 3D printing filament advancing mechanism 40 may be actuated or otherwise activated in response to actuation of an actuator 30. Embodiments of the actuator 30 may be an actuator, a trigger, a switch, a button, and the like. The actuator 30 may be a trigger that is at least partially located external to the housing 1 for actuation by a finger of a user. Furthermore, embodiments of the actuator 30 may include an engagement element 35. Engagement element 35 may be a switch engagement element, an element, an extension, or other structural portion of the actuator 30 that mat extend or otherwise protrude from the actuator 30. The engagement element 35 may be configured to depress a switch 41 of the motor 45 that activates or otherwise causes the motor to begin operating. In an exemplary embodiment, the actuator 30 may include a pivot point 36 to effectuate a pivot action/movement as the user pulls/presses the actuator 30, and as the user pulls/presses the actuator 30, the actuator 30 pivots about pivot point 36 as the actuator 30 further enters an interior region of the housing 1, while driving engagement element 35 into the switch 41 of the motor 45. In other words, pressing the trigger 30 of the 3D printing gun 100 activates a motor 45 within the housing 1, which causes the filament 5 to advance through the gun 100.

Embodiments of the motor 40 may thus be activated in response to the switch 41 being pressed, displaced, pushed, and the like. The motor 40 may be schematically shown in FIG. 2; embodiments of the motor 40 may be a gear motor, a low RPM motor, an electric motor, a servo motor, a brushless servo motor, a rotary actuator, a liner actuator, driver, and the like. Embodiments of the motor 40 may include a motor arm 46 that may interact with the first gear 42. The motor arm 46 may be an armature of the motor 40, an arm of the motor, or other component that is moved by the operation of the motor 40, wherein the movement of the motor arm 46 can be translated to movement of the first gear 42. Embodiments of the first gear 42 may be positioned proximate the motor arm 46 of the motor 40, such that when the actuator 30 is actuated by a user, the first gear 42 may be driven or otherwise caused to rotate, for example, in a counter-clockwise direction, by the motor arm 46. Rotation of the first gear 42, for in a counter-clockwise direction, may cause a second gear 43 to rotate in a clockwise direction. In other words, the first gear 42 meshes with the second gear 43 (e.g. teeth of the first gear 42 engage with teeth on the second gear 43). Further, rotation of the second gear 43 in a clockwise direction may cause the filament 5 to be advanced towards the front end 2b of the housing 1. For instance, the teeth of the second gear 43 may grip, grab, interfere with, bite, pinch, etc. the filament 5 to advance the filament 5.

A third gear 44 may be positioned above or otherwise proximate the second gear 43, which may act as a guide or secondary driving gear for advancing the filament 5. For example, the filament 5 may pass between the second gear 43 and the third gear 44, wherein the filament may be pinched between the gears 43, 44 to facilitate the advancing of the filament 5. In an alternative embodiment, the gears 43, 44 may instead be pinch rollers, wherein the pinch rollers are rotated directly by the motor 40 or other power source.

Furthermore, as shown in FIG. 2, the plurality of gears 42, 43, 44 may be located at a gap of the internal passageway 20, or in between the first support structure 22a and the second support structure 22b. Thus, the filament 5 may be fed into the opening 21 by the user and through the internal passageway 20 until a leading portion of the filament 5 contacts one or both of the second gear 43 and third gear 44. The user may receive feedback that the filament 5 has reached the gears 43, 44, and may then actuate the actuator 30 to operate the 3D printing gun 100 (e.g. advance the filament 5 through the heating element 60). In another embodiment, the user may feed the filament 5 through the internal passageway 20 and hold down the actuator 30 such that as soon as the filament 5 is moved into position, the filament 5 may be seamlessly advanced. Once the filament 5 is initial gripped by the gears 43, 44 and advanced a distance past the gears 43, 44, the filament 5 may not need to be manually fed again into the gears 43, 44; the advancing mechanism 40 may retain the filament in an advanceable position within the housing 1.

Embodiments of the 3D printing gun 100 may also include a heating element 60. Embodiments of the heating element 60 may be coupled to the front end 2b of the barrel portion 2 of the housing 1. Embodiments of the heating element 60 may include an internal bore 67 configured to receive the advanced filament 5 from the 3D printing filament advancing mechanism 40. The internal bore 67 may be aligned with the internal passageway 20, such that the filament 5 is seamlessly advanced through the second section of the internal passageway 20 and into the internal bore 67 of the heating element 60. Moreover, embodiments of the heating element 60 may be threadably engaged to the housing 1. The heating element 60 may include a threaded outer surface 61 that is configured to engage corresponding threads of the housing 1, proximate the front end 2b of the housing 1. Threadably attaching the heating element 60 may allow for quick attachment and reattachment for cleaning or swapping for other heating elements having a different size orifice or outlet area of the nozzle 62, a different thickness, or a different material to achieve desired thermal conductivity. Further, embodiments of the heating element 50 may be comprised of a conductive material, such as metal, metal alloy, and the like.

Embodiments of the heating element 60 may heat the 3D printing filament 5 as the filament 5 passes through the internal bore 67 of the heating element 60 to a hot molten 3D printing material to be discharged from an outlet of a nozzle 62 of the heating element 60. For instance, the filament 5 is melted as the filament cord is pushed through the heating element 60, and ultimately discharged as a drop or consistent flow of molten hot thermoplastic material. The hot molten filament may have a dispensing temperature between 200°-300° C.

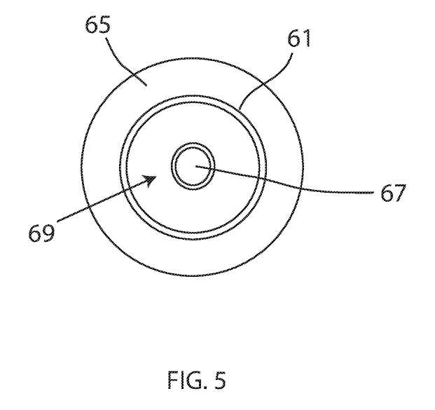

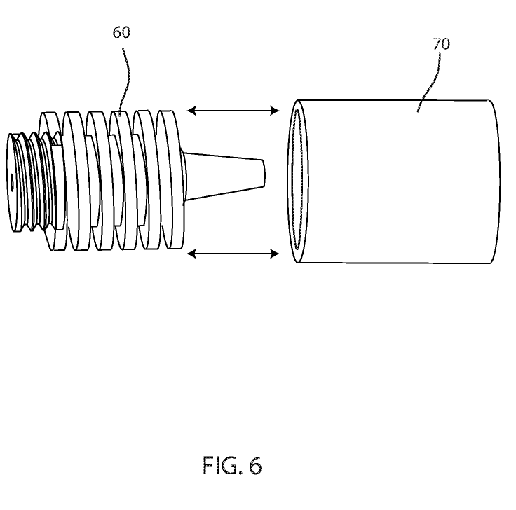

FIG. 5 depicts a rear view of the heating element 60, in accordance with embodiments of the present invention. The heat to melt the filament 5 may be provided by a heat source 50, which may be disposed within the heating element 60. Embodiments of the heat source 50 may be a heat coil disposed in a chamber 69 of the heating element. The heat source 50 may surround the internal bore 67, wherein the heat source may conduct and/or radiate heat through the heating element 60 and into the bore 67 to melt the filament 5. In another embodiment, the heat source 50 may be a plurality of heating elements disposed within the chamber 69. Moreover, embodiments of the heating element 60 may include a plurality of cooling fins 65 radially outwardly extending from the heating element 60. Embodiments of the cooling fins may be fins or generally annular members extending radially outwardly from heating element 60, which may provide heat dissipation towards the outer edge of the heating element 60, for improved safety and cooling purposes. For instance, the heat within the internal bore 67 may be significantly higher than a heat of the heating element 60 at the tip of the cooling fins 65, which may assist in keeping a temperature down at the front end 2b of the barrel portion 2.

Referring back to FIG. 2, embodiments of a power source 80 may provide the electricity to heat the heating source 50 disposed within the chamber 69 of the heating element 60. The power source may be a corded connection to an AC source of electricity. The power source 80 may be electrically coupled to a mains lead 81 (e.g. cord, mains cable, etc.) disposed within the housing 1 of the 3D printing gun 100. The mains lead 81 may eventually branch into a positive and negative wire, which may couple with an electrically corresponding receptacle on the heat source 50.

Furthermore, embodiments of the 3D printing gun 100 may include an insulator sleeve 70. FIG. 6 depicts the heating element receiving the insulator sleeve, in accordance with embodiments of the present invention. Embodiments of the insulator sleeve 70 may surround the heating element 60, and may be removable. The insulator sleeve 60 may provide safety to the user so that the user does not touch the heating element 60 after being heated by the heat source 50. Embodiments of the insulator sleeve 70 may be a generally annular member having a general axial opening therethrough. The axial opening may be large enough to receive the cooling fins 65 of the heating element 50, and may taper inwardly to fit snugly against the nozzle 62 of the heating element 60, or otherwise accommodate the shape of the nozzle 62. In an exemplary embodiment, the sleeve 70 may retained on the heating element 60 via an interference fit between the surface of the heating element 60 and the inner surface of the sleeve 70. Further, embodiments of the insulator sleeve 70 may be comprised of insulating materials.

With references to FIGS. 1-6, embodiment of a method of discharging a hot molten filament may include the steps of providing a 3D printing gun 100, the 3D printing gun 100 including a 3D printing filament source 10 removably attached to a housing 1 of the three-dimensional molding printing gun 100, a 3D filament advancing mechanism 40 configured to advance a 3D filament 5 through a barrel portion 2 of the housing 1 from a rear end 2a to a front end 2b, the 3D filament advancing mechanism 40 including a plurality of gears 42, 43, 44 configured to advance the 3D printing filament 5 towards the front end 2b of the barrel portion 2 of the housing 1, a heating element 60 coupled to the first end 2b of the barrel portion 2 of the housing 1, the heating element 60 having an internal bore 67 configured to receive the advanced 3D filament 5 from the 3D filament advancing mechanism 40, wherein the heating element 60 includes a plurality of cooling fins 55 radially extending from the heating element 60, and an insulator sleeve 70 surrounding the heating element 60, and in response to an actuation of an actuator 30: (i) advancing the 3D filament 5 through the barrel portion 2 of the housing 1, wherein the actuator 30 is a trigger that is at least partially located external to the housing 1 for actuation by a finger of a user, (ii) heating the 3D filament 5 to a hot molten 3D printing material to be discharged from an outlet of a nozzle 62 of the heating element 60.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A three-dimensional printing gun, comprising:
a 3D printing filament source removably attached to a housing of the three-dimensional printing gun;
a 3D filament advancing mechanism configured to advance a 3D filament through a barrel portion, the 3D filament advancing mechanism including a plurality of gears configured to advance the 3D filament towards the front end of the barrel portion of the housing, in response to an actuation of an actuator, the actuator being a trigger that is at least partially located external to the housing for actuation by a finger of a user;
a heating element coupled to the front end of the barrel portion of the housing, the heating element having an internal bore configured to receive the advanced 3D filament from the 3D filament advancing mechanism and heat the 3D filament to a hot molten 3D printing material to be discharged from an outlet of a nozzle of the heating element, as part of the actuation of the actuator, wherein the heating element includes a plurality of cooling fins radially extending from the heating element; and
an insulator sleeve surrounding the heating element;
wherein the actuation of the actuator controls the 3D printing filament advancing mechanism and a heating of the heating element.

2. The three-dimensional printing gun of claim 1, wherein the actuation of the actuator controls the 3D printing filament advancing mechanism and the heating of the heating element simultaneously.

3. The three-dimensional printing gun of claim 1, wherein the filament is a thermoplastic material.

4. The three-dimensional printing gun of claim 1, further comprising a mains lead electrically coupled to the heating element.

5. The three-dimensional printing gun of claim 1, wherein a dispensing temperature of the hot molten 3D printing material is between 200°-300° C.

6. The three-dimensional printing gun of claim 1, wherein the 3D printing filament advancing mechanism is an electric feed motor.

7. The three-dimensional printing gun of claim 1, wherein the heating element is threadably attached to the housing.

8. The three-dimensional printing gun of claim 1, wherein the front end of the barrel portion includes a recessed portion, the recessed portion including a threaded surface.

9. The three-dimensional printing gun of claim 8, wherein the heating element includes a threaded surface that correspondingly mates with the threaded surface of the recessed portion of the barrel portion of the housing.

10. The three-dimensional printing gun of claim 1, wherein the housing includes an internal passageway that accommodates the 3D filament through the housing, the internal passageway aligning with the internal bore of the heating element when the heating element is coupled to the housing.

11. The three-dimensional printing gun of claim 1, wherein the housing includes a handle portion, the handle portion being substantially perpendicular to the barrel portion, and gripped by a hand of the user.

12. The three-dimensional printing gun of claim 1, further comprising a power source disposed in a handle portion of the housing.

13. A 3D printing gun comprising:
a housing having a barrel portion and a handle portion perpendicular to the barrel portion, wherein a user grips the handle portion when using the 3D printing gun;
a 3D printing filament spool device fastened to the housing of the three-dimensional molding printing gun;
a 3D filament advancing mechanism for advancing the 3D filament through an internal passageway of the barrel portion, the 3D filament advancing mechanism including a first gear positioned proximate a motor arm in the barrel portion of the housing, the first gear meshing with a second gear positioned below the 3D filament, the second gear cooperating with a third gear positioned above the 3D filament, such that the 3D filament is advanced towards the front end of the barrel portion via contact with the second gear and the third gear;
a heating element threadably coupled to the first end of the barrel portion of the housing, the heating element having an internal bore aligned with the internal passageway of the barrel portion, and configured to receive the advanced 3D filament from the 3D filament advancing mechanism and heat the 3D filament to a hot molten 3D printing material to be discharged from an outlet of a nozzle of the heating element, wherein the heating element includes a plurality of cooling fins radially extending from the heating element; and
an insulator sleeve surrounding the heating element;
wherein, when a trigger is pulled by a user: (i) a portion of the trigger located inside the housing makes contact with a switch of a gear motor located inside the housing, which actuates the motor arm connected to the first gear, which causes motion of the first gear and the second gear to advance the 3D filament for dispensing from the nozzle as a hot molten filament, and (ii) the heating element is caused to melt the 3D filament located within the internal bore of the heating element.

14. The 3D printing gun of claim 13, wherein the 3D printing gun is portable.

15. The 3D printing gun of claim 13, wherein the 3D printing gun is used to fuse together or repair 3D printed objects on a salesfloor.

16. The 3D printing gun of claim 13, wherein the 3D printing gun operates between 120° C.-370° C.

17. A method of fusing together two or more 3D printed objects using the 3D printing gun of claim 1.

18. A method of discharging a hot molten filament, the method comprising:
providing a 3D printing gun, the 3D printing gun including a 3D printing filament source removably attached to a housing of the three-dimensional molding printing gun, a 3D filament advancing mechanism configured to advance a 3D filament through a barrel portion of the housing from a rear end to a front end, the 3D filament advancing mechanism including a plurality of gears configured to advance the 3D filament towards the front end of the barrel portion of the housing, a heating element coupled to the first end of the barrel portion of the housing, the heating element having an internal bore configured to receive the advanced 3D filament from the 3D filament advancing mechanism, wherein the heating element includes a plurality of cooling fins radially extending from the heating element, and an insulator sleeve surrounding the heating element; and
in response to an actuation of an actuator: (i) advancing the 3D filament through the barrel portion of the housing, wherein the actuator is a trigger that is at least partially located external to the housing for actuation by a finger of a user, (ii) heating the 3D filament to a hot molten 3D printing material to be discharged from an outlet of a nozzle of the heating element.

19. The method of claim 19, wherein the filament is melted to a temperature between 200°-300° C. proximate an outlet of the nozzle.

20. The 3D printing gun of claim 13, wherein the 3D printing gun is used to fuse together or repair 3D printed objects on a salesfloor.
